(19) United States
(12) Patent Application Publication
(10) Pub. No.: US 2026/0106182 A1
(43) Pub. Date: Apr. 16, 2026

(54) FUEL CELL STACK

(71) Applicant: TOYOTA JIDOSHA KABUSHIKI KAISHA, Toyota-shi (JP)

(72) Inventor: Nobuaki NONOYAMA, Chiryu-shi (JP)

(73) Assignee: TOYOTA JIDOSHA KABUSHIKI KAISHA, Toyota-shi (JP)

(21) Appl. No.: 19/225,433

(22) Filed: Jun. 2, 2025

(30) Foreign Application Priority Data
Oct. 10, 2024 (JP) 2024-177666

(51) Int. Cl. H01M 8/026; H01M 8/0273

(52) U.S. Cl. CPC H01M 8/026; H01M 8/0273

(57) ABSTRACT

In a fuel cell stack including multiple cells that are stacked, a first cell includes a membrane electrode assembly, a frame, a pair of separators that sandwiches the membrane electrode assembly held by the frame, and an elastic body including a base portion and multiple column portions protruding from the base portion. A first separator included in the first cell includes a groove portion on a first surface. The base portion of the elastic body is disposed in the groove portion. The base portion covers a bottom surface of the groove portion, and at least some of the column portions are disposed along a direction in which the groove portion extends. In a flow passage space for a coolant, tip ends of the column portions of the elastic body disposed in the groove portion of the first separator are in contact with a second separator included in a second cell.

### CROSS-REFERENCE TO RELATED APPLICATION

This application claims priority to Japanese Patent Application No. 2024-177666 filed on Oct. 10, 2024. The disclosure of the above-identified application, including the specification, drawings, and claims, is incorporated by reference herein in its entirety.

### BACKGROUND

### 1. Technical Field

The present disclosure relates to a fuel cell stack.

### 2. Description of Related Art

In the technique described in Japanese Unexamined Patent Application Publication No. 2021-97001 (JP 2021-97001 A), a displacement suppression member is disposed in a flow passage space for a coolant. The flow passage space for the coolant is provided with a separator included in one cell among a plurality of cells configuring a fuel cell stack and a separator included in another cell stacked on the one cell. The displacement suppression member is fixed to the separator provided in the one cell in order to suppress the displacement of the separator due to the fluctuation of the pressure of the coolant flowing through the flow passage space. The displacement suppression member has a plurality of protruding portions and connecting pieces that connect the protruding portions to each other. Tip ends of the protruding portions are in contact with a separator facing the separator to which the displacement suppression member is fixed.

### SUMMARY

In the technique described in JP 2021-97001 A, a pressure of the coolant flowing through the flow passage space is applied to the displacement suppression member. In a case where the pressure of the coolant is increased, there is a possibility that the positional deviation of the displacement suppression member or peeling of the displacement suppression member from the separator may occur.

The present disclosure can be implemented as the following aspects.

(1) According to one aspect of the present disclosure, a fuel cell stack is provided.

In the fuel cell stack,
a first cell among a plurality of cells includes
a membrane electrode assembly,
a frame that holds the membrane electrode assembly,
a pair of separators that sandwiches the membrane electrode assembly held by the frame, and one or more elastic bodies that include a base portion and a plurality of column portions protruding from the base portion.
   A first separator that is one of the separators included in the first cell includes one or more groove portions on a first surface that is a surface opposite to a surface facing the other of the separators included in the first cell.
   The base portion of the one or more elastic bodies is disposed in the one or more groove portions,
the base portion covers a bottom surface of the one or more groove portions, and
at least some of the column portions are disposed along a direction in which the one or more groove portions extend.
   In a flow passage space for a coolant provided between the first cell and a second cell adjacent to the first cell, the flow passage space is a gap provided by stacking a second separator included in the second cell on the first surface of the first separator included in the first cell, tip ends of the column portions of the one or more elastic bodies disposed in the one or more groove portions of the first separator are in contact with the second separator included in the second cell.
   According to the above aspect, the base portion that is a part of the elastic body is disposed in the groove portion to cover the bottom surface of the groove portion provided in the first separator. Therefore, the area of the elastic body that is directly in contact with the coolant can be reduced, as compared with an aspect in which a part of the elastic body is not disposed in the groove portion. Therefore, the force that the base portion of the elastic body receives from the coolant can be reduced. Therefore, the positional deviation of the elastic body and the occurrence of peeling can be suppressed, as compared with the aspect in which a part of the elastic body is not disposed in the groove portion.

(2) In the fuel cell stack according to the above aspect,
the one or more elastic bodies include a first elastic body and a second elastic body,
each of the first elastic body and the second elastic body has a wall portion protruding from the base portion, in addition to the base portion and the column portions.
   The first separator is provided with a supply manifold that supplies the coolant to the flow passage space and a discharge manifold that discharges the coolant from the flow passage space,
a first groove portion among the one or more groove portions is provided on the first surface of the first separator to surround the supply manifold, and
a second groove portion among the one or more groove portions is provided on the first surface of the first separator to surround the discharge manifold.
   The column portions of the first elastic body may be disposed downstream of the wall portion of the first elastic body in a direction from the supply manifold toward the discharge manifold by disposing the base portion of the first elastic body in the first groove portion, and the column portions of the second elastic body may be disposed upstream of the wall portion of the second elastic body in the direction from the supply manifold toward the discharge manifold by disposing the base portion of the second elastic body in the second groove portion.
   According to the above aspect, in the first elastic body disposed to surround the supply manifold that supplies the coolant to the flow passage space, the column portions are disposed downstream of the wall portion in the direction from the supply manifold toward the discharge manifold. In the second elastic body disposed to surround the discharge manifold that discharges the coolant from the flow passage space, the column portions are disposed upstream of the wall portion. Therefore, the flow of the coolant can be made smooth.

(3) In the fuel cell stack according to the above aspect,
in a state where the membrane electrode assembly held by the frame is sandwiched between the first separator and the other of the separators included in the first cell,
a second surface of the first separator opposite to the first surface may be in contact with the frame at a position behind a position where the one or more groove portions are provided.
   In a state where the fuel cell stack is completed, the elastic body disposed in the flow passage space applies a load to the frame via the first separator in a state where the cells are stacked. As a result, the frame and the membrane electrode assembly attached to the frame in a state of being sandwiched between the separators are fixed in position. According to the above aspect, the positional deviation of the elastic body and the occurrence of peeling can be suppressed, as compared with the aspect in which a part of the elastic body is not disposed in the groove portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view showing a fuel cell according to the present embodiment;

FIG. 2 is a cross-sectional view cut along the line II-II in FIG. 1;

FIG. 3 is a cross-sectional view showing a state where two fuel cells are stacked;

FIG. 4 is an explanatory view showing an example of an appearance shape of an elastic portion; and

FIG. 5 is a cross-sectional view cut along the line V-V in FIG. 1.

### DETAILED DESCRIPTION OF EMBODIMENTS

### A. Embodiment

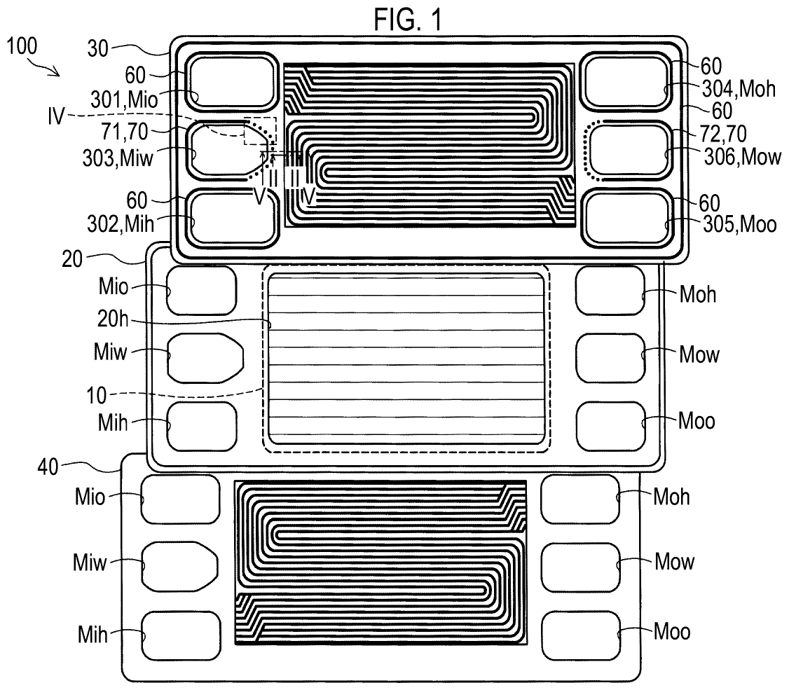

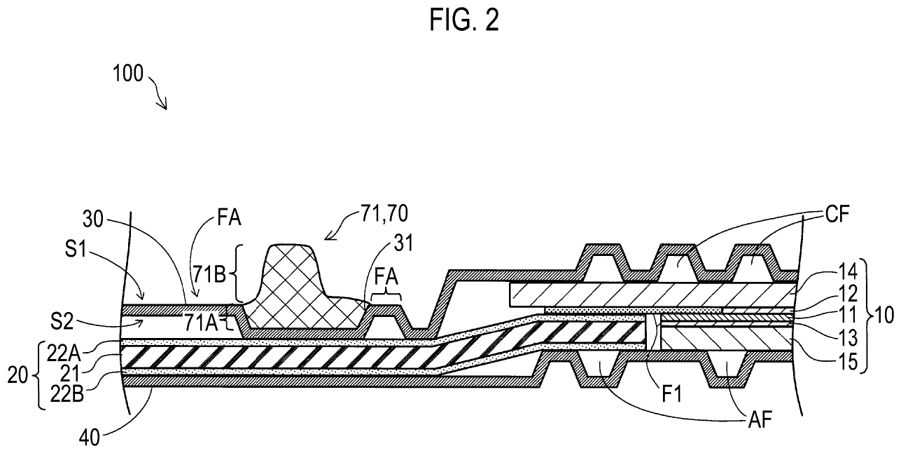

FIG. 1 is an exploded perspective view showing a fuel cell 100 according to the present embodiment. FIG. 2 is a cross-sectional view cut along the line II-II in FIG. 1. The fuel cell 100 is a solid polymer fuel cell that generates power by receiving supply of hydrogen and oxygen as reaction gases. A fuel cell stack is configured by stacking a plurality of the fuel cells 100.

As shown in FIG. 1, the fuel cell 100 includes a membrane electrode assembly (MEA) 10, a resin sheet 20, a pair of separators 30, 40, a seal portion 60, and an elastic portion 70. The fuel cell 100 is also simply referred to as a “cell”. The elastic portion 70 is also referred to as an “elastic body”. The resin sheet 20 is also referred to as a “frame”.

As shown in FIG. 2, the membrane electrode assembly 10 includes an electrolyte membrane 11, a first electrode catalyst layer 12, a second electrode catalyst layer 13, a first gas diffusion layer 14, and a second gas diffusion layer 15. The first electrode catalyst layer 12 functions as a cathode electrode provided on one surface of the electrolyte membrane 11. The second electrode catalyst layer 13 functions as an anode electrode provided on the other surface of the electrolyte membrane 11. The first gas diffusion layer 14 is provided on a surface of the first electrode catalyst layer 12 that does not come into contact with the electrolyte membrane 11. The second gas diffusion layer 15 is provided on a surface of the second electrode catalyst layer 13 that does not come into contact with the electrolyte membrane 11. The electrolyte membrane 11 is formed of, for example, an ion exchange membrane of a fluororesin. The first electrode catalyst layer 12 and the second electrode catalyst layer 13 are formed of, for example, a carbon carrier supporting a platinum catalyst. The first gas diffusion layer 14 and the second gas diffusion layer 15 are formed of, for example, a carbon cloth.

As shown in FIG. 1, the resin sheet 20 is a frame-shaped member that holds the membrane electrode assembly 10. For example, an outer peripheral portion of the membrane electrode assembly 10 is joined to an inner peripheral portion of the through hole 20h on the center of the resin sheet 20 by an adhesive film F1 (see FIG. 2) that is a sheet-shaped hot melt adhesive. The membrane electrode assembly 10 is exposed on the front surface and the back surface of the resin sheet 20.

As shown in FIG. 2, the resin sheet 20 includes a core layer 21 and adhesive layers 22A, 22B provided on both surfaces of the core layer 21. It is preferable that the materials constituting the core layer 21 and the adhesive layers 22A, 22B are selected such that the melting point of the core layer 21 is higher than the melting points of the adhesive layers 22A, 22B. The core layer 21 is formed of, for example, polyethylene naphthalate (PEN). The adhesive layers 22A, 22B are formed of, for example, a modified olefin-based hot melt adhesive.

As shown in FIG. 1, the separators 30, 40 sandwich the membrane electrode assembly 10 held by the resin sheet 20. The separators 30, 40 are joined to the resin sheet 20 by the adhesive layers 22A, 22B. The separators 30, 40 are formed of, for example, stainless steel, titanium, or an alloy thereof. The separators 30, 40 are provided with unevenness formed by press molding. As shown in FIG. 2, a flow passage CF through which an oxidizing gas (cathode gas) flows is provided between the separator 30 and the membrane electrode assembly 10 by the unevenness provided in the separator 30. A flow passage AF through which a fuel gas (anode gas) flows is provided between the separator 40 and the membrane electrode assembly 10 by the unevenness provided in the separator 40.

As shown in FIG. 1, a plurality of through holes is provided in each of the resin sheet 20 and the separators 30, 40. The through holes constitute a plurality of manifolds in a state where the resin sheet 20 is sandwiched between the separators 30, 40. The manifolds include a supply manifold Mio, a supply manifold Mih, a supply manifold Miw, a discharge manifold Moo, a discharge manifold Moh, and a discharge manifold Mow. The supply manifold Mio supplies the oxidizing gas to the membrane electrode assembly 10. The supply manifold Mih supplies the fuel gas to the membrane electrode assembly 10. The supply manifold Miw supplies the coolant. The discharge manifold Moo discharges the oxidizing gas used in the reaction in the membrane electrode assembly 10. The discharge manifold Moh discharges the fuel gas used in the reaction in the membrane electrode assembly 10. The discharge manifold Mow discharges the coolant that receives the heat generated in the membrane electrode assembly 10. In FIG. 1, the six through holes provided in the separator 30 are denoted by reference numerals 301 to 306.

As shown in FIG. 2, two groove portions 31 formed by press molding are provided on a surface S1 of the separator 30. One groove portion 31 is provided to surround the through hole 303 of the separator 30. The other groove portion 31 is provided to surround the through hole 306. The groove portion 31 surrounding the through hole 306 of the separator 30 is not shown in FIG. 2. A surface S2 of the separator 30 is in contact with the resin sheet 20 at a position behind a position where the groove portion 31 is provided in a state where the membrane electrode assembly 10 held by the resin sheet 20 is sandwiched between the separator 30 and the separator 40. The groove portion 31 surrounding the through hole 306 of the separator 30 is also defined in the same manner. The use of the groove portion 31 will be described later. The surface S1 is also referred to as a “first surface”. The surface S2 is also referred to as a “second surface”.

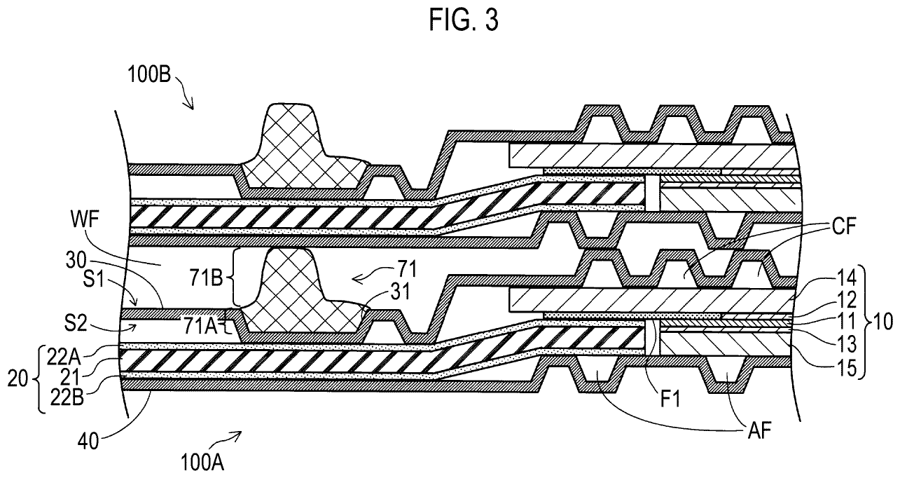

FIG. 3 is a partial cross-sectional view showing a state where two fuel cells 100 are stacked. The fuel cell 100 disposed on the lower side is referred to as a fuel cell 100A, and the fuel cell 100 disposed on the upper side is referred to as a fuel cell 100B. The fuel cell 100B is adjacent to the fuel cell 100A on the side opposite to the separator 40 of the fuel cell 100A with respect to the separator 30 of the fuel cell 100A. A gap provided by stacking the separator 40 of the fuel cell 100B on the separator 30 of the fuel cell 100A constitutes a flow passage space WF through which a coolant for controlling the temperature of the membrane electrode assembly 10 flows. The fuel cell 100A is also referred to as a “first cell”. The fuel cell 100B is also referred to as a “second cell”. The separator 30 of the fuel cell 100A is also referred to as a “first separator”. The separator 40 of the fuel cell 100B is also referred to as a “second separator”.

As shown in FIG. 1, the seal portion 60 seals the flow passage CF of the oxidizing gas and the flow passage AF of the fuel gas such that the oxidizing gas and the fuel gas do not enter the flow passage space WF. The seal portion 60 is formed of, for example, a rubber gasket formed of ethylene propylene diene monomer (EPDM) or the like, or a cured in place gasket (CIPG). The seal portion 60 is joined to the surface S1 that is a surface not facing the membrane electrode assembly 10 of the separator 30 and the resin sheet 20. The seal portion 60 is disposed to surround the through hole 301, the through hole 302, the through hole 304, and the through hole 305 independently. Further, the seal portion 60 is disposed along the outer periphery of the separator 30.

As shown in FIG. 1, the elastic portion 70 includes an elastic portion 71 and an elastic portion 72. As shown in FIG. 2, the elastic portions 71, 72 are joined to the surface S1 that is a surface not facing the membrane electrode assembly 10 of the separator 30 and the resin sheet 20. As shown in FIG. 1, the elastic portion 71 is disposed in the groove portion 31 provided around the through hole 303. Therefore, the elastic portion 71 is disposed to surround the through hole 303 constituting the supply manifold Miw. Although not shown in FIG. 2, the elastic portion 72 is disposed in the groove portion 31 provided around the through hole 306. Therefore, the elastic portion 72 is disposed to surround the through hole 306 constituting the discharge manifold Mow (see FIG. 1). The elastic portions 71, 72 are, for example, formed by injection molding on the separator 30 in a state where the unevenness including the groove portions 31 is formed by press molding.

The elastic portions 71, 72 are disposed in the flow passage space WF to suppress displacement of the separator 30 of the fuel cell 100A and the separator 40 of the fuel cell 100B. This is because the fluctuation of the pressure of the coolant in the flow passage space WF, the fluctuation of the temperature of the coolant, and the warp at the time of manufacturing the cell may cause the displacement of the separator 30 of the fuel cell 100A and the separator 40 of the fuel cell 100B. The displacement of the separators 30, 40 leads to a variation in the flow rate of the coolant in the flow passage space WF, and consequently, leads to a decrease in the cooling efficiency and a decrease in the power generation efficiency. The groove portion 31 surrounding the through hole 303 is also referred to as a “first groove portion”. The groove portion 31 surrounding the through hole 306 is also referred to as a “second groove portion”. The elastic portion 71 is also referred to as a “first elastic body”. The elastic portion 72 is also referred to as a “second elastic body”.

In a state where the fuel cell stack is completed, the fuel cell 100 is stacked. In this state, the elastic portions 71, 72 disposed in the flow passage space WF apply a load to the resin sheet 20 via the separator 30. In a case where the cathode gas pressure and the anode gas pressure are higher than the pressure of the coolant, the sealing property of the joint portion between the resin sheet 20 and the separators 30, 40 is deteriorated. By applying a load to the resin sheet 20 by the elastic portions 71, 72, the seal between the resin sheet 20 and the separators 30, 40 in a state of being sandwiched between the separators 30, 40 can be made strong.

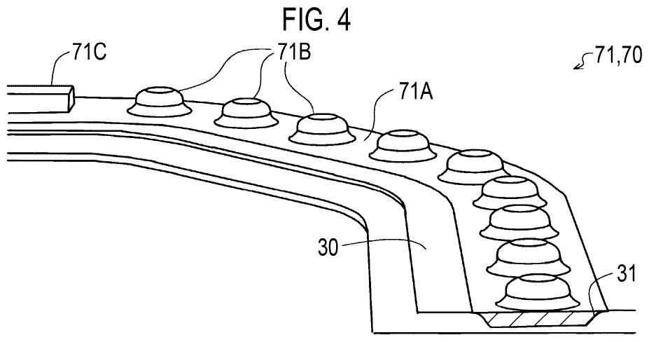

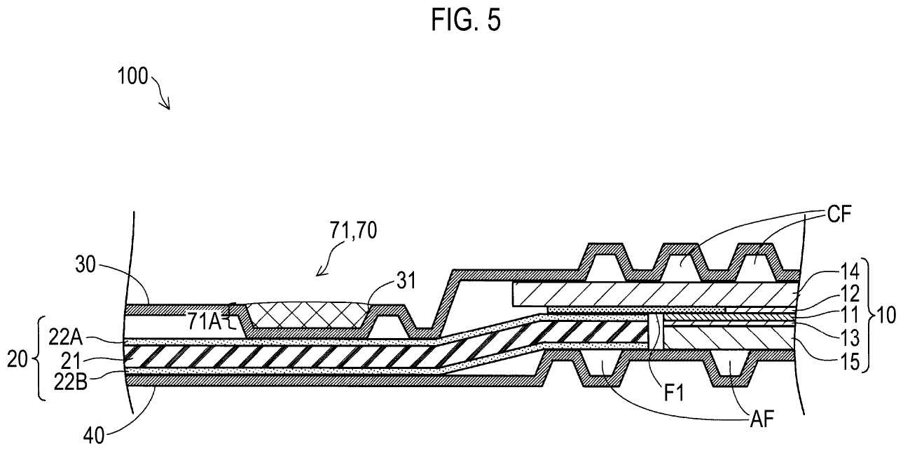

FIG. 4 is an explanatory view showing an example of an appearance shape of the elastic portion 71. FIG. 4 is a perspective view of the elastic portion 71 of the portion surrounded by the square frame IV indicated by the broken line in FIG. 1. FIG. 5 is a cross-sectional view cut along the line V-V in FIG. 1. Hereinafter, the elastic portion 71 will be described as an example, but the elastic portion 72 also has the same configuration. The elastic portion 71 includes a base portion 71A, a plurality of column portions 71B, and a wall portion 71C. The column portions 71B and the wall portions 71C protrude from the base portion 71A. The base portion 71A is disposed to cover a bottom surface of the groove portion 31. It is desirable that the base portion 71A is disposed over the entire bottom surface of the groove portion 31, but the base portion 71A may not be provided in a part of the bottom surface of the groove portion 31. The column portions 71B are disposed along the direction in which the groove portion 31 extends. The two column portions 71B adjacent to each other are disposed at a predetermined distance. The wall portion 71C is disposed along the direction in which the groove portion 31 extends. As shown in FIG. 3, a tip end of the column portion 71B of the elastic portion 71 included in the fuel cell 100A is in contact with the separator 40 included in the fuel cell 100B. Although not shown, a tip end of the wall portion 71C is in contact with the separator 40 included in the fuel cell 100B.

A characteristic configuration in the present embodiment is that the elastic portions 71, 72 are disposed in corresponding groove portions 31 provided in the separator 30. The merits of disposing the elastic portions 71, 72 in the groove portions 31 will be described. Hereinafter, the elastic portion 71 will be described as an example, but the elastic portion 72 is also defined in the same manner.

First, a pressure is applied to the elastic portions 71, 72 by the flow of the coolant in the flow passage space WF. When the pressure of the flow of the coolant increases, the pressure applied to the elastic portions 71, 72 also increases. In this case, a possibility of the positional deviation of the elastic portions 71, 72 with respect to the separator 30 or the occurrence of peeling of the elastic portions 71, 72 from the separator 30 is increased.

According to the present embodiment, the base portion 71A that is a part of the elastic portion 71 is disposed in the groove portion 31 to cover the bottom surface of the groove portion 31 provided in the separator 30. Therefore, the area of the elastic portion 71 that is directly in contact with the coolant can be reduced and the force that the elastic portion 71 receives from the coolant can be reduced, as compared with the aspect in which the base portion 71A of the elastic portion 71 is not disposed in the groove portion 31. Therefore, the positional deviation of the elastic portion 71 and the occurrence of peeling can be suppressed.

According to the present embodiment, the area of the elastic portion 71 that is directly in contact with the coolant can be reduced, as compared with the aspect in which the base portion 71A that is a part of the elastic portion 71 is not disposed in the groove portion 31. Therefore, the flow of the coolant in the flow passage space WF can be made smooth. From the viewpoint of the power generation efficiency, it is preferable that the coolant uniformly flows in the flow passage space WF, but there is a possibility that the flow of the coolant may be inhibited by the elastic portion 71 disposed in the flow passage space WF. According to the above aspect, the occurrence of such a problem can be suppressed. Therefore, an increase in pressure loss of the coolant in the flow passage space WF can be suppressed. As a result, a decrease in the power generation efficiency can be suppressed.

In the present embodiment, the column portions 71B of the elastic portion 71 are disposed downstream of the wall portion 71C in a direction from the supply manifold Miw toward the discharge manifold Mow (see FIGS. 1 and 5). In the supply manifold Miw, since the wall portion 71C is disposed on the upstream side, the flow of the coolant is not inhibited. The column portions 72B of the elastic portion 72 are disposed upstream of the wall portion 72C in the direction from the supply manifold Miw toward the discharge manifold Mow. In the discharge manifold Mow, since the wall portion 72C is disposed on the downstream side, the flow of the coolant is not inhibited. Therefore, the flow of the coolant can be made smooth.

### B. Other Embodiment

(B1) In the above-described embodiment, an example in which the elastic portion 71 has the wall portion 71C has been described, but the elastic portion 71 may not have the wall portion 71C. For example, the elastic portion 71 may include the base portion 71A and the column portions 71B, and the column portions 71B may be disposed to surround the supply manifold Miw. The elastic portion 72 is also defined in the same manner.

(B2) The elastic portion 71 may be configured such that a part of the column portion 71B of the elastic portion 71 interferes with a flat side portion FA (see FIG. 2) adjacent to the groove portion 31. In addition, the elastic portion 71 may be configured such that a part of the base portion 71A of the elastic portion 71 interferes with the flat side portion that is continuous with the groove portion 31. The portion of the base portion 71A of the elastic portion 71 exposed to the flow passage space WF may be provided with unevenness. In addition, one and the other of the flat side portions on the both sides of the groove portion 31 may be configured to have different heights from each other.

(B3) Further, the bottom surface of the groove portion 31 may be provided with unevenness. By forming the unevenness on the bottom surface of the groove portion 31, the joint state between the base portion 71A and the bottom surface of the groove portion 31 can be made strong, and the effect of suppressing the positional deviation of the elastic portion 71 and the occurrence of peeling is further improved. The same applies to the groove portion provided around the through hole 306 and the elastic portion 72.

The present disclosure is not limited to the above-described embodiments, and can be implemented with various configurations without departing from the gist of the present disclosure. For example, the technical features of the embodiments corresponding to the technical features in each of the embodiments described in the section of SUMMARY can be appropriately replaced or combined in order to solve a part or all of the problems described above. For example, the technical features of the embodiments corresponding to the technical features in each of the embodiments described in the section of SUMMARY can be appropriately replaced or combined in order to achieve a part or all of the effects described above. In addition, in a case where the technical features are not described as being always needed in the present specification, the features can be deleted as appropriate.

What is claimed is:

1. A fuel cell stack comprising a plurality of cells that is stacked, wherein:
a first cell among the cells includes
a membrane electrode assembly,
a frame that holds the membrane electrode assembly,
a pair of separators that sandwiches the membrane electrode assembly held by the frame, and
one or more elastic bodies that include a base portion and a plurality of column portions protruding from the base portion;
a first separator that is one of the separators included in the first cell includes one or more groove portions on a first surface that is a surface opposite to a surface facing the other of the separators included in the first cell;
the base portion of the one or more elastic bodies is disposed in the one or more groove portions;
the base portion covers a bottom surface of the one or more groove portions;
at least some of the column portions are disposed along a direction in which the one or more groove portions extend; and
in a flow passage space for a coolant provided between the first cell and a second cell adjacent to the first cell, the flow passage space being a gap provided by stacking a second separator included in the second cell on the first surface of the first separator included in the first cell, tip ends of the column portions of the one or more elastic bodies disposed in the one or more groove portions of the first separator are in contact with the second separator included in the second cell.

2. The fuel cell stack according to claim 1, wherein:
the one or more elastic bodies include a first elastic body and a second elastic body;
each of the first elastic body and the second elastic body has a wall portion protruding from the base portion, in addition to the base portion and the column portions;
the first separator is provided with a supply manifold that supplies the coolant to the flow passage space and a discharge manifold that discharges the coolant from the flow passage space;
a first groove portion among the one or more groove portions is provided on the first surface of the first separator to surround the supply manifold;
a second groove portion among the one or more groove portions is provided on the first surface of the first separator to surround the discharge manifold;
the column portions of the first elastic body are disposed downstream of the wall portion of the first elastic body in a direction from the supply manifold toward the discharge manifold by disposing the base portion of the first elastic body in the first groove portion; and
the column portions of the second elastic body are disposed upstream of the wall portion of the second elastic body in the direction from the supply manifold toward the discharge manifold by disposing the base portion of the second elastic body in the second groove portion.

3. The fuel cell stack according to claim 2, wherein in a state where the membrane electrode assembly held by the frame is sandwiched between the first separator and the other of the separators included in the first cell, a second surface of the first separator opposite to the first surface is in contact with the frame at a position behind a position where the one or more groove portions are provided.
